(19) United States
(12) Patent Application Publication
(10) Pub. No.: US 2026/0300941 A1
(43) Pub. Date: Oct. 1, 2026

(54) Quantum-Resilient Decentralized Social Media System

(71) Applicant: Adam Denoto, Brook Park, OH (US)

(72) Inventor: Adam Denoto, Brook Park, OH (US)

(21) Appl. No.: 19/452,508

(22) Filed: Jan. 19, 2026

Related U.S. Application Data
(60) Provisional application No. 63/780,578, filed on Mar. 31, 2025.

(51) Int. Cl. G06Q 10/46; H04L 9/14

(52) U.S. Cl. CPC G06Q 10/46; H04L 9/14

(57) ABSTRACT

A quantum-resilient decentralized social media system is disclosed. The system includes a mobile application that enables users to create and interact with content, manage cryptocurrency assets, utilize artificial intelligence tools, and participate in decentralized governance. An API gateway provides quantum-resistant secure communication with a server-side services module comprising a social media engine, an artificial intelligence engine, a finance and trading module, a quantum security module, and a governance module. A distributed node network implements a three-dimensional spherical blockchain architecture to immutably record social activity, financial transactions, governance actions, and security validations. In some embodiments, methods are provided for initializing user accounts using cryptographic wallets and post-quantum keys, for generating and monetizing content through blockchain storage and micro-payment distribution, and for executing automated cryptocurrency trading using an AI-driven trading bot with results recorded on the blockchain.

### CROSS-REFERENCE TO RELATED APPLICATION

The present application claims priority to, and the benefit of, U.S. Provisional Application No. 63/780,578 which was filed on Mar. 31, 2025 and is incorporated herein by reference in its entirety.

### FIELD OF THE INVENTION

The present invention generally relates to social networking platforms. More specifically, the present invention relates to a quantum-resilient decentralized social media system that integrates a multi-component technological framework enabling users to securely create, store, monetize, and govern digital content without reliance on centralized control. The invention comprises a distributed system including a client (i.e., mobile application) executed on a user device, an API (Application Programming Interface) gateway for secure communication handling, and a server-side services module incorporating a social media engine, an artificial intelligence engine, a finance and trading module, a quantum security module, and a governance module. The system communicates with a plurality of blockchain nodes implementing a three-dimensional spherical blockchain architecture configured to immutably record posts, engagement events, financial transactions, and governance actions. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional social media platforms operate under centralized control structures in which a single entity manages data storage, user interactions, moderation policies, and economic participation. Such centralized architectures can create vulnerabilities and limitations. For example, users may be subject to moderation practices that appear biased or inconsistent, resulting in posts, comments, or accounts being removed without transparency or recourse. Centralized servers and legacy security mechanisms may also expose social media platforms to a variety of cyber threats, including hacking, data breaches, and manipulation of stored content.

Further, in many existing platforms, monetization opportunities are limited primarily to advertisers or high-profile creators, leaving ordinary users unable to participate meaningfully in revenue generation. Payment models can be unequal, and most user engagement does not result in direct financial benefit to the individuals who produce or interact with content. As a result, conventional social media systems may fail to provide equitable compensation, security protection, or transparent governance mechanisms for their users. Accordingly, individuals desire a decentralized social media platform that provides cybersecurity, free speech, and equitable monetization.

Therefore, there exists a long-felt need in the art for an improved social media system that overcomes the limitations inherent in traditional centralized platforms. There is a long-felt need for a system that reduces the ability of centralized authorities to unilaterally remove, suppress, or alter user content. Additionally, there exists a need for a social media platform capable of withstanding emerging cybersecurity threats, including the heightened risks introduced by quantum computing technologies. Moreover, there is a need for an environment in which ordinary users participate in equitable monetization models and receive compensation for their contributions and engagement. Finally, there is a need for a system that provides users with greater control over their identity, governance participation, digital assets, and personal data while maintaining transparency, security, and resistance to censorship.

The subject matter disclosed and claimed herein, in one embodiment, comprises a quantum-resilient decentralized social media system designed to provide enhanced security, censorship resistance, equitable monetization, and integrated blockchain-AI functionality. The system includes a client (i.e., mobile application) executed on a user device, the client (i.e., mobile application) providing graphical interfaces for creating posts, consuming content, managing cryptocurrency assets, engaging with artificial intelligence tools, and participating in decentralized governance activities. The client (i.e., mobile application) communicates with an API gateway that manages routing, authentication, session control, and enforcement of quantum-resistant communication protocols. A server-side services module implements the platform's core functionality through several subsystem engines, including a social media engine, an artificial intelligence engine, a finance and trading module, a quantum security module, and a governance module. The components collectively enable secure content handling, automated financial transactions, NFT generation, AI-assisted trading, and petition management. A distributed blockchain node network implementing a three-dimensional spherical blockchain architecture immutably records user content, interactions, transactions, and governance actions.

In one embodiment, the artificial intelligence engine includes a content creation module configured to generate or augment user content through machine-learning models capable of producing text, images, video, or multimedia compositions. The AI engine may further incorporate an autonomous trading bot that executes cryptocurrency transactions based on predictive analytics, sentiment analysis, and reinforcement learning strategies. A recommendation module provides personalized content and financial insights based on user behavior. In another embodiment, the quantum security module incorporates post-quantum cryptographic algorithms, a non-computational analog validation hash function, and optional quantum key distribution capabilities to protect communications from quantum-enabled cyberattacks. Additional embodiments provide a governance module that enables decentralized petition creation, digital signature verification, and automatic submission to designated institutions when predetermined thresholds are reached.

In this manner, the quantum-resilient decentralized social media system of the present invention overcomes long-standing deficiencies in the art by providing users with a secure, censorship-resistant, and economically inclusive digital environment. The decentralized and three-dimensional spherical blockchain architecture ensures data integrity, immutability, and resistance to manipulation, even in the presence of advanced quantum computing threats. The integration of AI-assisted content creation, autonomous trading tools, and smart-contract-based monetization enables users to benefit financially from their engagement while maintaining full control over their digital identity and assets. Additionally, the governance capabilities of the system empower users to participate in transparent, verifiable civic processes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a quantum-resilient decentralized social media system that integrates a client (i.e., mobile application), an API gateway, multiple backend service modules, and a distributed blockchain node network. The client (i.e., mobile application) enables users to create and interact with social media content, manage cryptocurrency assets, access AI-based tools, and participate in decentralized governance. The API gateway manages authentication, request routing, session control, and quantum-safe communication protocols. On the server side, the system includes a social media engine, an artificial intelligence engine, a finance and trading module, a quantum security module, and a governance module. A distributed node network implements a three-dimensional spherical blockchain architecture that records social activity, financial transactions, governance actions, and security validations with immutability and censorship resistance.

In another embodiment, the invention provides a method for initializing a secure user account within a quantum-resilient social media platform. The method includes creating a user profile on a client (i.e., electronic) device, generating a cryptographic wallet linked to that profile, and establishing quantum-resistant cryptographic keys that protect user transactions and communications. The platform secures the user's identity and assets under potential quantum-based attacks. The method further includes storing initialization data across a three-dimensional spherical blockchain structure, providing tamper-resistant and censorship-resistant protection for account information.

In a further embodiment, the invention provides a method for generating, publishing, and monetizing user content using a decentralized blockchain architecture. The method begins with receiving user-generated content through the client (i.e., mobile application), including text, images, multimedia files, petitions, or digital artwork. The system stores the content on a three-dimensional spherical blockchain by creating a blockchain record that includes hashed data and metadata. Engagement interactions, such as likes, dislikes, comments, shares, and views, are then monitored and analyzed. Based on the interactions, a micro-payment engine distributes digital currency rewards to the cryptographic wallet of the user, thereby enabling automated, transparent monetization of user activity.

In still another embodiment, the invention provides a non-transitory computer-readable medium containing instructions that direct one or more processors to carry out an automated AI-driven cryptocurrency trading process. When executed, the instructions cause the system to establish a secure connection between the user's cryptographic wallet and a finance and trading module. The system then uses an artificial intelligence trading bot to execute cryptocurrency trades based on predictive analytics, market trends, or engagement signals. After executing the trades, the system generates performance and transaction results and immutably records the results on a three-dimensional spherical blockchain architecture.

In some embodiments of the system, the artificial intelligence engine includes a plurality of submodules to improve user engagement and system functionality. The submodules include an AI content creation engine that generates multimedia content, an AI-powered trading bot that autonomously executes cryptocurrency transactions, and a recommendation module that provides personalized suggestions for content, communities, governance activities, or investment opportunities.

In another embodiment, the quantum security module incorporates a quantum key distribution (QKD) system that enables the generation of photon-based or entanglement-based cryptographic keys. The keys secure communication channels between the client (i.e., mobile application) and backend servers.

In some implementations of the content-monetization method, the distribution of digital currency rewards is governed by smart-contract logic. The smart-contract framework evaluates engagement metrics such as content reach, interaction frequency, and virality to determine the appropriate reward amount for a creator.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates block architecture diagram of quantum-resilient decentralized social media system of the present invention in accordance with the disclosed structure;

FIG. 2 illustrates a block diagram showing a configuration of the artificial intelligence (AI) engine included in the quantum-resilient decentralized social media system, according to an embodiment of the present invention;

FIG. 3 illustrates a block diagram showing configuration of the quantum security module, according to an embodiment of the present invention;

FIG. 4 illustrates a block diagram showing components of the finance and trading module utilized within the quantum-resilient decentralized social media system, according to an embodiment of the present invention;

FIG. 5 illustrates a flowchart depicting steps for initializing a user account and securing user credentials in the quantum-resilient decentralized social media system, according to one embodiment of the present invention;

FIG. 6 illustrates a flowchart depicting steps for generation and monetization of user content in the quantum-resilient decentralized social media system, according to one embodiment of the present invention;

FIG. 7 illustrates a flowchart depicting steps for performing automated cryptocurrency trading using the quantum-resilient decentralized social media system, according to one embodiment of the present invention; and

FIG. 8 illustrates a flowchart depicting steps of executing a decentralized petition workflow in the quantum-resilient decentralized social media system, according to one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved social media system that overcomes the limitations inherent in traditional centralized platforms. There is a long-felt need for a system that reduces the ability of centralized authorities to unilaterally remove, suppress, or alter user content. Additionally, there exists a need for a social media platform capable of withstanding emerging cybersecurity threats, including the heightened risks introduced by quantum computing technologies. Moreover, there is a need for an environment in which ordinary users participate in equitable monetization models and receive compensation for their contributions and engagement. Finally, there is a need for a system that provides users with greater control over their identity, governance participation, digital assets, and personal data while maintaining transparency, security, and resistance to censorship.

The present invention, in one exemplary embodiment, is a method for generating, publishing, and monetizing user content using a decentralized blockchain architecture. The method begins with receiving user-generated content through the client (i.e., mobile application), including text, images, multimedia files, petitions, or digital artwork. The system stores the content on a three-dimensional spherical blockchain by creating a blockchain record that includes hashed data and metadata. Engagement interactions, such as likes, dislikes, comments, shares, and views, are then monitored and analyzed. Based on the interactions, a micro-payment engine distributes digital currency rewards to the cryptographic wallet of the user, thereby enabling automated, transparent monetization of user activity.

Reference will now be made in detail to the present preferred embodiments of the invention, examples of which are illustrated in the accompanying drawings. Wherever possible, the same reference numerals are used in the drawings and the description to refer to the same or like parts.

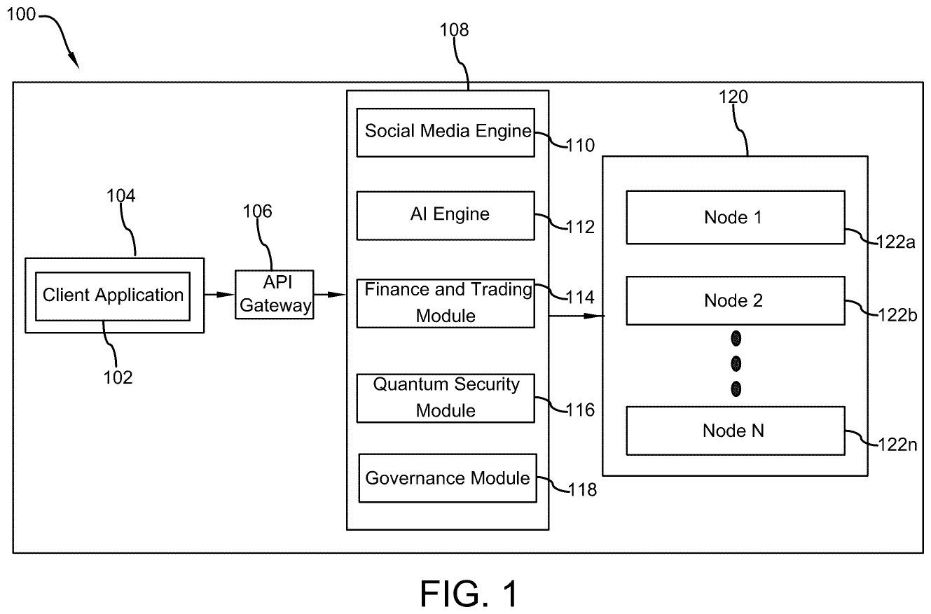

Referring initially to the drawings, FIG. 1 illustrates block architecture diagram of quantum-resilient decentralized social media system of the present invention in accordance with the disclosed structure. The quantum-resilient decentralized social media system 100 of the present invention is designed as a decentralized, quantum-resilient social networking system to provide cybersecurity, censorship resistance, and integrated blockchain-AI functionality. More specifically, the social media system 100 is configured as a future-proof social ecosystem that is secure even under advanced quantum computing attacks. The system 100 also provides users with true control over content, identity, finances, and governance.

The system 100 includes a client (i.e., mobile application) 102 that executes on a client (i.e., electronic) device 104, such as a mobile phone, tablet computer, laptop computer, desktop workstation, augmented-reality device, or any other computing platform capable of network communication. The client (i.e., mobile application) 102 provides one or more graphical user interfaces through which users can generate and publish posts, view and interact with content, manage cryptocurrency assets, access artificial intelligence-based functionality, and participate in governance activities facilitated by the platform.

The client (i.e., mobile application) 102 communicates with a backend computing environment via an API gateway 106. The API gateway 106 serves as an interface and control layer responsible for receiving client-originated requests, routing such requests to appropriate backend modules, performing session management, enforcing authentication requirements, and applying quantum-resistant secure-communication protocols. In certain embodiments, the API gateway 106 can additionally implement rate limiting, message signing, payload validation, and pre-processing of user requests prior to transmission to backend services.

As further illustrated in FIG. 1, the API gateway 106 interfaces with a server-side services module 108, which comprises multiple subsystems collectively implementing the core functionality of the quantum-resilient social media platform. The server-side services module 108 includes a social media engine 110, an AI engine 112, a finance and trading module 114, a quantum security module 116, and a governance module 118.

The social media engine 110 manages user-facing social-networking operations, including the creation and maintenance of user profiles, the generation, publication, and retrieval of posts, the handling of comment threads and reaction events, and the assembly of personalized and system-wide content feeds. The social media engine 110 may also administer encrypted messaging workflows, multimedia asset processing, and interaction-tracking functions used to determine engagement-based micro-payment rewards.

The AI engine 112 provides machine-learning-based functionality that supports and enhances multiple aspects of the system 100. In various embodiments, the AI engine 112 can generate or assist in generating text, images, video, and other multimedia content; offer content-creation suggestions; perform automated moderation analysis while preserving censorship-resistant principles; conduct predictive modeling for social trend forecasting or financial indicators; and generate NFT artwork or tokenized digital content. The AI engine 112 may also operate trading decision-support algorithms or autonomous trading agents that interact with the financial systems described below.

The finance and trading module 114 performs blockchain-based financial operations including the purchase, sale, exchange, and transfer of cryptocurrencies and digital assets. The module 114 further manages execution of micro-payment reward transactions distributed to users based on interactions such as likes, dislikes, comments, and content generation. In some embodiments, the finance and trading module 114 interfaces with smart-contract logic configured to automate monetization workflows, creator compensation, royalty distribution, and other financial processes. The module 114 can additionally support AI-generated or user-defined investment strategies and provide performance tracking of user portfolios.

The quantum security module 116 performs the quantum-resistant cryptographic operations deployed in the system 100, including the generation and management of post-quantum key pairs, quantum-safe encryption and decryption of user data and communications, and validation of data integrity. In some embodiments, the quantum security module 116 additionally supports integration with quantum key distribution (QKD) channels or other quantum-enhanced communication infrastructures when available in the deployment environment.

The governance module 118 provides decentralized governance functionality that enables users to participate in platform-wide civic or political engagement processes. The governance module 118 administers workflows for creating petitions, collecting digital signatures, verifying identities or anonymous participation through zero-knowledge proofs, and evaluating signature thresholds required for automated submission of petitions to designated government entities or other authorities.

As shown in FIG. 1, the server-side services module 108 interfaces with a distributed node network 120, which includes a plurality of blockchain nodes 122a-122n. Each node of the plurality of blockchain nodes 122a-122n participates in maintaining a distributed ledger that records social media activity, user engagement events, financial transactions, governance actions, and security validations. In the preferred embodiment, the nodes 122a-122n implement a 3D spherical blockchain architecture with multi-vector consensus protocols that implements immutability, censorship resistance, data integrity, and resilience against cyber-attacks.

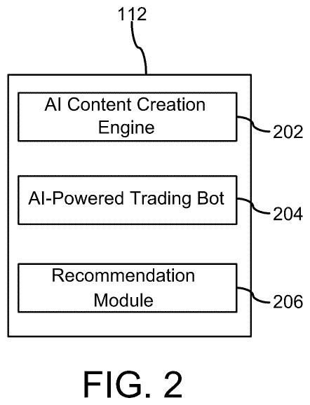

FIG. 2 illustrates a block diagram showing a configuration of the artificial intelligence (AI) engine included in the quantum-resilient decentralized social media system, according to an embodiment of the present invention. The AI engine 112 includes an AI content creation engine or module 202, which is configured to generate or assist in generating various forms of user content.

The AI content creation engine 202 may produce text, images, audio, video, or multimedia compositions, and can provide creative suggestions, automated drafting, style refinement, or template generation to enhance user productivity. The AI content creation engine 202 can additionally support the creation of NFT artwork or tokenized media assets for use within the system's blockchain-based marketplace.

The AI engine 112 further includes an AI-powered trading bot 204, which functions as an autonomous or semi-autonomous trading agent capable of analyzing blockchain data, market conditions, user engagement metrics, and other financial indicators. Based on the analysis, the AI-powered trading bot 204 can execute cryptocurrency trades, manage digital asset portfolios, or provide decision-support recommendations for users. In some embodiments, the trading bot 204 employs machine-learning models, predictive analytics, and reinforcement-learning strategies to optimize trading performance.

A recommendation module 206, provides personalized recommendations to users based on their activity patterns, interests, social interactions, or financial behavior within the system 100. The recommendation module 206 can generate suggestions relating to content, creators, communities, petitions, digital assets, or trading strategies. The AI content creation engine 202, the AI-powered trading bot 204, and the recommendation module 206 form an integrated artificial intelligence subsystem for augmenting user engagement and automating creative and financial tasks.

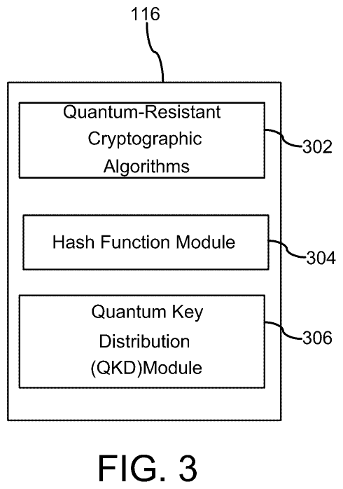

FIG. 3 illustrates a block diagram showing configuration of the quantum security module, according to an embodiment of the present invention. In the illustrated embodiment, the quantum security module 116 includes a quantum-resistant cryptographic algorithms module 302, which can implement one or more post-quantum cryptographic operations or techniques for securing communications and transactions executed within the system 100.

The algorithms module 302 may incorporate one or more from lattice-based cryptographic schemes, multivariate quadratic signature systems, code-based cryptography, hash-based signature algorithms, or other NIST-endorsed post-quantum primitives. The module 302 is configured to resist or block attacks from quantum computers capable of performing operations such as Shor's algorithm or Grover's search.

The quantum security module 116 further includes a hash function module 304 that is configured to provide data-integrity verification and block-validation. In some embodiments, the hash function module 304 implements a non-computational analog validation hash function designed to generate hash values based on physical or analog entropy sources, making the hash function difficult or impossible for quantum computers to reverse, replicate, or brute-force. The hash function module 304 can also perform block-linking operations for the three-dimensional spherical blockchain architecture, providing immutability and resistance to tampering.

A quantum key distribution (QKD) module 306 provides QKD channels or other quantum-enhanced communication infrastructures for providing security to the communication within the system 100. The QKD module 306 can generate photon-based or entanglement-based shared secret keys between communicating endpoints (such as server-side services module 108 and the mobile application 102) and may apply keys to sensitive or high-security data exchanges. In embodiments where QKD networks are not available, the QKD module 306 may default to post-quantum key-exchange protocols provided by the algorithms module 302.

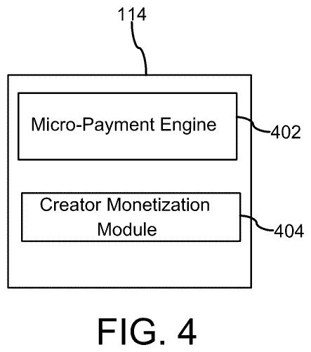

FIG. 4 illustrates a block diagram showing components of the finance and trading module utilized within the quantum-resilient decentralized social media system, according to an embodiment of the present invention. In the illustrated embodiment, the finance and trading module 114 includes a micro-payment engine 402, which is configured to calculate, generate, and distribute small-value digital currency transactions associated with user engagement events. The engagement events can include, without limitation, posting content, receiving reactions, commenting, sharing, viewing content, or participating in governance activities. In various embodiments, the micro-payment engine 402 can also maintain user reward histories, allocate payments based on predefined engagement algorithms, and communicate updates to user wallets managed by the system 100.

The finance and trading module 114 further includes a creator monetization module 404, that facilitates direct compensation and revenue-generating opportunities for content creators. The creator monetization module 404 may manage processes such as automated distribution of creator earnings, allocation of platform tokens or cryptocurrency rewards, processing of premium subscription payments, and management of digital collectible or NFT-based revenue streams.

In some embodiments, the creator monetization module 404 is configured to evaluate content performance metrics such as reach, interactions, or virality and calculate corresponding payouts using machine-learning-based valuation models stored in the AI engine 112. The module 404 can additionally interface with external or internal trading systems to enable creators to automatically reinvest earnings through AI-driven or custom-defined trading strategies.

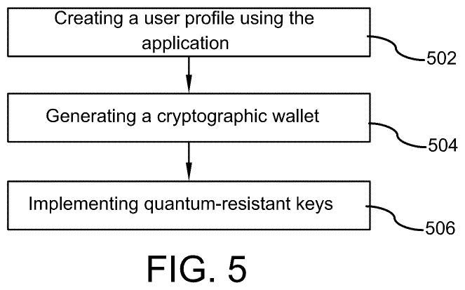

FIG. 5 illustrates a flowchart depicting steps for initializing a user account and securing user credentials in the quantum-resilient decentralized social media system, according to one embodiment of the present invention. Initially, a user profile is created of a user using the application (Step 502). A user may interact with the client (i.e., mobile application) to enter identity information, profile attributes, or additional account settings required for platform operation. The system can store the profile information locally, remotely, or across distributed nodes.

Then, the system creates a digital wallet associated with the user profile (Step 504). The cryptographic wallet can store one or more blockchain addresses, private-public key pairs, digital signatures, token balances, micro-payment records used for financial transactions or governance operations. The wallet may be generated locally on the client (i.e., electronic) device 104, within a secure enclave (not shown), or via the server-side services module 108.

Then, the system implements quantum-resistant keys (Step 506). The system 100 establishes one or more post-quantum cryptographic keys associated with the cryptographic wallet and user identity. The quantum-resistant keys can include lattice-based keys, multivariate polynomial keys, hash-based signatures, or other post-quantum algorithms designed to withstand computational attacks from classical and quantum sources.

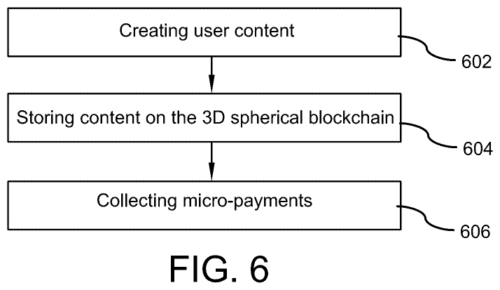

FIG. 6 illustrates a flowchart depicting steps for generation and monetization of user content in the quantum-resilient decentralized social media system, according to one embodiment of the present invention. Initially, a user creates user content using the mobile application 102 (Step 602). The user utilizes the client (i.e., mobile application) to generate one or more content items, such as text posts, images, videos, multimedia files, petitions, NFT artwork, or other forms of digital expression. In some embodiments, the AI engine of the system may assist in generating the content by providing AI-driven drafting, style enhancement, or media generation.

Then, user content is stored on the 3D spherical blockchain (Step 604). The system 100 may process the submitted user content and creates a corresponding blockchain record formatted for storage in the three-dimensional spherical blockchain architecture of the system 100. The spherical blockchain structure increases redundancy, tamper resistance, and immutability. The blockchain record can include a hashed representation of the content, timestamps, metadata, engagement statistics, or other associated data.

Thereafter, the system performs collecting micro-payments (Step 606). The system may track user interactions associated with the content such as likes, dislikes, comments, shares, or views and calculates corresponding reward values based on predefined monetization rules of the system 100. The micro-payment engine 402 of the finance and trading module 114 can generate automated cryptocurrency transactions that credit the wallet with micro-payments proportional to engagement.

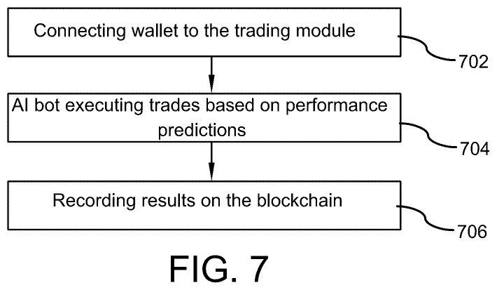

FIG. 7 illustrates a flowchart depicting steps for performing automated cryptocurrency trading using the quantum-resilient decentralized social media system, according to one embodiment of the present invention. The system 100 connects digital wallet of the user to the trading module when, a user authorizes (using the mobile application 102) to link the cryptographic wallet to the finance and trading module of the system (Step 702).

Then, the AI bot 204 executes trades based on performance predictions (Step 704). The AI-powered trading bot may evaluate real-time and historical market information, social engagement metrics of the user, crypto token performance indicators, and predictive signals generated by machine-learning models of the AI engine. Based on the analysis, the AI trading bot may autonomously execute buy, sell, or trade operations within the wallet of the user. In some embodiments, the AI bot may employ reinforcement learning, probabilistic modeling, sentiment analysis, or risk scoring to optimize trading strategies and maximize expected returns while adhering to user-defined constraints or platform policies.

Finally, the system records trading results on the blockchain network (Step 706). It should be noted that all trade-related transactions including executed orders, updated balances, fees, and trade outcomes are transmitted to the decentralized blockchain network for validation and permanent storage. The blockchain record may also store metadata such as timestamps, trading bot identifiers for review and verification of the transactions.

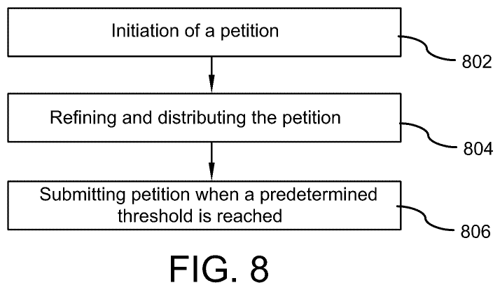

FIG. 8 illustrates a flowchart depicting steps of executing a decentralized petition workflow in the quantum-resilient decentralized social media system, according to one embodiment of the present invention. Initially, a user interacts with the client (i.e., mobile application) to draft a petition relating to a social, political, or community matter (Step 802). The user may define the subject matter, intended recipients, signature requirements, and other metadata of the petition. In some embodiments, the system may enable anonymous or pseudonymous petition creation through zero-knowledge authentication techniques, maintaining user privacy and petition authenticity.

Then, the governance module 118 can use AI-based natural language processing to refine the petition text, improve clarity, and to maintain consistency with platform formatting requirements (Step 804). The system then distributes the petition across the decentralized social media network, making it visible to users who may review and digitally sign it. Signature collection may be performed using blockchain-based verification, quantum-resistant cryptographic signatures, or privacy-preserving digital credentials.

After distribution and signature collection, the system 100 submits the petition when a predetermined threshold is reached (Step 806). The governance module continuously monitors the number of verified signatures and determines whether the petition has reached the required threshold established by the creator of the petition or by system policy. Once the threshold is satisfied, the system automatically packages the petition along with verification metadata such as signature counts, timestamps, cryptographic proofs and transmits the petition to one or more designated governmental entities, agencies, or institutional recipients.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “quantum-resilient decentralized social media system”, “social media system”, “decentralized social media system”, and “system” are interchangeable and refer to the quantum-resilient decentralized social media system 100 of the present invention.

Notwithstanding the forgoing, the quantum-resilient decentralized social media system 100 of the present invention can be of any suitable configuration as is known in the art without affecting the overall concept of the invention, provided that it accomplishes the above stated objectives. One of ordinary skill in the art will appreciate that the quantum-resilient decentralized social media system 100 shown in the FIGS. are for illustrative purposes only, and that many other configurations of the quantum-resilient decentralized social media system 100 are well within the scope of the present disclosure. Although the dimensions of the quantum-resilient decentralized social media system 100 are important design parameters for user convenience, the quantum-resilient decentralized social media system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decentralized social media system comprising:
a social networking system, wherein said social networking system is decentralized;
a mobile application;
a server-side services module;
an API gateway;
a distributed node network;
a plurality of blockchain nodes;
a recommendation engine;
a quantum security module; and
a quantum key distribution (QKD) module;
wherein said social networking system provides users with information selected from one or more of the group consisting of content, identity, finances, and governance;
wherein said mobile application executes on an electronic device with a network communication;
wherein said mobile application provides for one or more selected from the group consisting of graphical user interfaces, manage cryptocurrency assets, access artificial intelligence-based functionality, and participate in governance activities;
wherein said mobile application connected with said API gateway;
wherein said API gateway receives client-originated requests and routes said client-originated requests;
wherein said distributed node network comprises said plurality of blockchain nodes;
wherein each node of said plurality of blockchain nodes comprises a distributed ledger that records one or more selected from the group consisting of social media activity, user engagement events, financial transactions, governance actions, and security validations;
wherein said recommendation module comprises personalized recommendations to the user based on one or more selected from the group consisting of activity patterns, interests, social interactions, and financial behavior;
wherein said recommendation module generates one or more suggestions selected from the group consisting of content, creators, communities, petitions, digital assets, and trading strategies;
wherein said quantum security module comprises quantum-resistant cryptographic operations configured to incorporate one or more selected from the group consisting of lattice-based cryptographic schemes, multivariate quadratic signature systems, code-based cryptography, hash-based signature algorithms, and NIST-endorsed post-quantum primitives; and
further wherein said QKD module generates one or more selected from the group consisting of photon-based shared secret keys and entanglement-based shared secret keys between said server-side services module and said mobile application.

2. The decentralized social media system of claim 1, wherein said API gateway interfaces with said server-side services module selected from one or more of the group consisting of a social media engine, an AI engine, a finance and trading module, said quantum security module, and a governance module.

3. The decentralized social media system of claim 2, wherein said social media engine manages user-facing social-networking operations comprising one or more from the group consisting of creation of user profiles, maintenance of user profiles, generation of posts, publication of posts, retrieval of posts, handling of comment threads, and assembly of system-wide content feeds.

4. The decentralized social media system of claim 2, wherein said AI engine included in the decentralized social media system is configured to generate user content selected from the group consisting of text, images, audio, video, and multimedia compositions.

5. The decentralized social media system of claim 4, wherein said AI engine comprises an AI-powered trading bot configured to analyze one or more selected from the group consisting of blockchain data, market conditions, and user engagement metrics.

6. The decentralized social media system of claim 5, wherein said AI-powered trading bot executes one or more selected from the group consisting of cryptocurrency trades, manage digital asset portfolios, and decision-support recommendations for the user.

7. The decentralized social media system of claim 2, wherein said finance and trading module performs blockchain-based financial operations selected from the group consisting of purchase, sale, exchange, and transfer of cryptocurrencies.

8. The decentralized social media system of claim 1, wherein said quantum security module performs said quantum-resistant cryptographic operations selected from the group consisting of generation and management of post-quantum key pairs, quantum-safe encryption and decryption of user data and communications, and validation of data integrity.

9. The decentralized social media system of claim 2, wherein said governance module administers one or more selected from the group consisting of workflows for creating petitions, collecting digital signatures, verifying identities or anonymous participation through zero-knowledge proofs, and evaluating signature thresholds required for automated submission of petitions to designated government entities.

10. The decentralized social media system of claim 7, wherein said finance and trading module comprises a micro-payment engine configured to perform one or more selected from the group consisting of calculating, generating, and distributing small-value digital currency transactions associated with user engagement events.

11. The decentralized social media system of claim 10, wherein said user engagement events selected from one or more of group consisting of posting content, receiving reactions, commenting on content, sharing of content, and viewing content.

12. The decentralized social media system of claim 1, wherein said quantum-resistant cryptographic operations blocks attacks from quantum computers capable of performing operations selected from the group consisting of Shor's algorithm and Grover's search.

13. A decentralized social media system comprising:
a social networking system, wherein said social networking system is decentralized;
a mobile application;
a server-side services module;
an API gateway;
a recommendation engine;
a quantum security module;
a quantum key distribution (QKD) module; and
an AI engine;
wherein said social networking system provides users with information selected from one or more of the group consisting of content, identity, finances, and governance;
wherein said mobile application executes on an electronic device with a network communication;
wherein said mobile application provides for one or more selected from the group consisting of graphical user interfaces, manage cryptocurrency assets, access artificial intelligence-based functionality, and participate in governance activities;
wherein said mobile application connected with said API gateway;
wherein said API gateway receives client-originated requests and routes said client-originated requests;
wherein said recommendation module comprises personalized recommendations to the user based on one or more selected from the group consisting of activity patterns, interests, social interactions, and financial behavior;
wherein said recommendation module generates one or more suggestions selected from the group consisting of content, creators, communities, petitions, digital assets, and trading strategies;
wherein said quantum security module comprises quantum-resistant cryptographic operations configured to incorporate one or more selected from the group consisting of lattice-based cryptographic schemes, multivariate quadratic signature systems, code-based cryptography, hash-based signature algorithms, and NIST-endorsed post-quantum primitives;
wherein said QKD module generates one or more selected from the group consisting of photon-based shared secret keys and entanglement-based shared secret keys between said server-side services module and said mobile application;
wherein said AI engine included in the decentralized social media system is configured to generate user content selected from the group consisting of text, images, audio, video, and multimedia compositions; and
further wherein said AI engine comprises an AI-powered trading bot configured to analyze one or more selected from the group consisting of blockchain data, market conditions, and user engagement metrics.

14. The decentralized social media system of claim 13, wherein said API gateway interfaces with said server-side services module selected from one or more of the group consisting of a social media engine, said AI engine, a finance and trading module, said quantum security module, and a governance module.

15. The decentralized social media system of claim 14, wherein said social media engine manages user-facing social-networking operations comprising one or more from the group consisting of creation of user profiles, maintenance of user profiles, generation of posts, publication of posts, retrieval of posts, handling of comment threads, and assembly of system-wide content feeds.

16. The decentralized social media system of claim 13, wherein said AI-powered trading bot executes one or more selected from the group consisting of cryptocurrency trades, manage digital asset portfolios, and decision-support recommendations for the user.

17. The decentralized social media system of claim 14, wherein said finance and trading module performs blockchain-based financial operations selected from the group consisting of purchase, sale, exchange, and transfer of cryptocurrencies.

18. The decentralized social media system of claim 13, wherein said quantum security module performs said quantum-resistant cryptographic operations selected from the group consisting of generation and management of post-quantum key pairs, quantum-safe encryption and decryption of user data and communications, and validation of data integrity.

19. The decentralized social media system of claim 14, wherein said governance module administers one or more selected from the group consisting of workflows for creating petitions, collecting digital signatures, verifying identities or anonymous participation through zero-knowledge proofs, and evaluating signature thresholds required for automated submission of petitions to designated government entities.

20. A method of operating a quantum-resilient decentralized social media for managing cryptocurrency assets, the method comprising the steps of:
initializing a user account;
securing the user credentials in the quantum-resilient decentralized social media;
creating a user profile with a mobile application comprising information selected from one or more of the group consisting of user identity information, profile attributes, and account settings;
creating a cryptographic digital wallet associated with said user profile, wherein said cryptographic digital wallet stores information selected from one or more of the group consisting of blockchain addresses, private-public key pairs, digital signatures, token balances, micro-payment records used for financial transactions, and micro-payments used for governance operations;
implementing quantum-resistant keys and associating said quantum-resistant keys with said cryptographic digital wallet and said user identity information;
wherein said quantum-resistant keys selected from one or more of the group consisting of lattice-based keys, multivariate polynomial keys, hash-based signatures, and post-quantum algorithms configured to withstand computational attacks from quantum sources;
generating one or more content items selected from the group consisting of text posts, images, videos, multimedia files, petitions, and NFT artwork; and
executing trades based on performance predictions from an AI-powered trading bot, wherein said AI-powered trading bot evaluates one or more of the group consisting of real-time market information, historical market information, social engagement metrics of the user, crypto token performance indicators, and predictive signals generated by machine-learning models of said AI trading bot.
